(19) United States
(12) Patent Application Publication
(10) Pub. No.: US 2005/0112405 A1
(43) Pub. Date: May 26, 2005

(54) Organic electroluminescent element

(76) Inventor: Yuji Hamada, Ikoma-gun (JP)

Correspondence Address: KUBOVCIK & KUBOVCIK, SUITE 710, 900 17TH STREET NW, WASHINGTON, DC, 20006, US

(21) Appl. No.: 10/952,499

(22) Filed: Sep. 29, 2004

(30) Foreign Application Priority Data
Sep. 30, 2003 (JP) 2003-342604

(51) Int. Cl. H05B 33/14

(52) U.S. Cl. 428/690; 428/917; 313/504; 313/506; 313/112; 257/98

(57) ABSTRACT

The invention relates to an organic electroluminescent element provided with a red-orange light-emitting layer and a blue light-emitting layer which are laminated on each other and disposed between a pair of electrodes, wherein the red-orange light-emitting layer contains a luminescent material represented by the following formula (1): 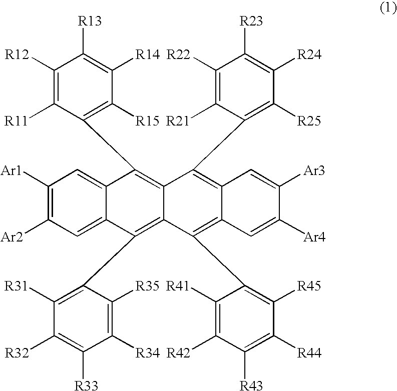
wherein R11 to R15, R21 to R25, R31 to R35 and R41 to R45, which may be identical to or different from each other, respectively represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a heterocyclic group represented by the following formula (2), provided that at least one of these groups is a heterocyclic group and Ar1 to Ar4, which may be identical to or different from each other, respectively represent an aromatic substituent selected from the group (3) represented by the following formula: 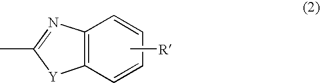
wherein Y represents oxygen (O) or sulfur (S), R′ represents hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by −N(CₙH₂ₙ₊₁)₂ (n denotes an integer from 1 to 10), fluorine, chlorine, bromine, iodine, a cyano group or a phenyl group; 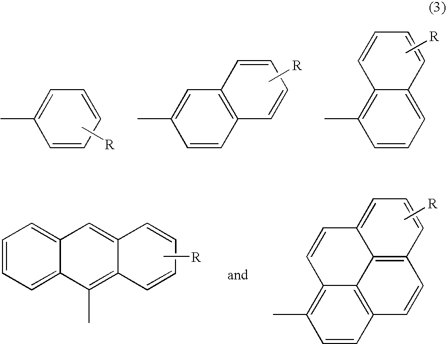
wherein R represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a phenyl group.

### BACKGROUND OF THE INVENTION

1. Field of the Invention

The present invention relates to an organic electroluminescent element which is provided with a red-orange light-emitting layer and a blue light-emitting layer and emits white light.

2. Descriptions of the Related Art

It is possible to make organic electroluminescent elements (hereinafter referred to as an organic EL element) emit white light by laminating a red-orange light-emitting layer and a blue light-emitting layer. It is therefore possible to make a full-color display by combining this white light-emitting organic EL element with a color filter in the same manner as in the case of a liquid crystal display device.

Naphthacene derivatives such as rubrene are known as an organic EL element luminescent materials having strong fluorescence and exhibiting high brightness. However, the light emitted from rubrene has a yellow to orange color and rubrene cannot be therefore used for the aforementioned red-orange light-emitting layer (e.g., the publication of JP-A No. 2003-55652).

For this, studies have been made to make the light emitted from rubrene and the like have a longer wavelength from old and studies are being made concerning a change of the substituent of naphthacene derivatives and a change in fundamental skeleton from naphthacene to pentacene (e.g., a pamphlet of WO 99/57221).

These methods have succeeded in making longer the wavelength of naphthacene derivatives but not succeeded in improving the emission life of an element yet.

### SUMMARY OF THE INVENTION

It is an object of the present invention to provide an organic EL element which can emit white light having high color purity by using a novel luminescent material in a red-orange light emitting layer.

The present invention relates to an organic EL element provided with a red-orange light-emitting layer and a blue light-emitting layer which are laminated on each other and disposed between a pair of electrodes, wherein the red-orange light-emitting layer contains a luminescent material represented by the following formula (1): 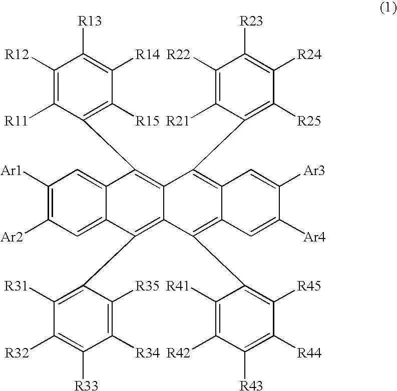
wherein R11 to R15, R21 to R25, R31 to R35 and R41 to R45, which may be identical to or different from each other, respectively represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a heterocyclic group represented by the following formula (2), provided that at least one of these groups is a heterocyclic group and Ar1 to Ar4, which may be identical to or different from each other, respectively represent an aromatic substituent selected from the group (3) represented by the following formula: 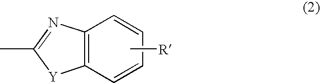
wherein Y represents oxygen (O) or sulfur (S), R′ represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a phenyl group; 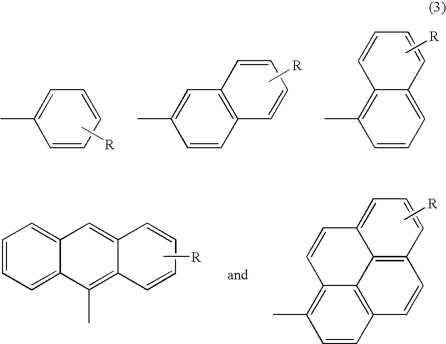
   wherein R represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a phenyl group.

Examples of a compound used as the luminescent material of the red-orange light-emitting layer in the present invention include compounds such as those represented by the following formulae (4) to (6).

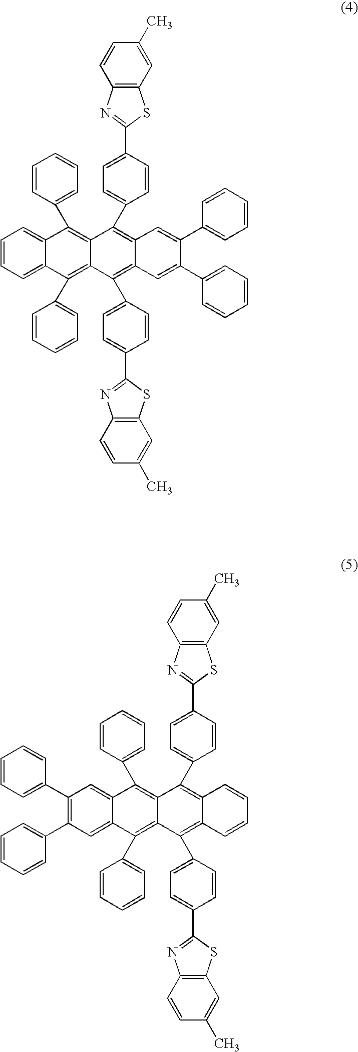

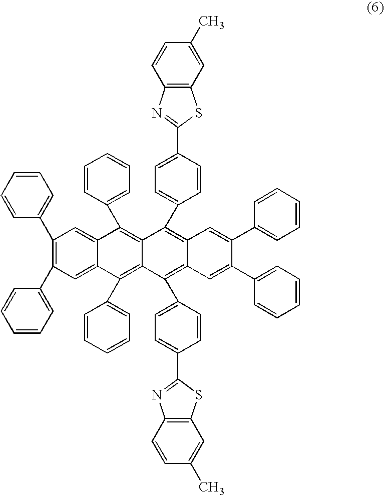

Because the luminescent material used for the red-orange light-emitting layer in the present invention can emit red-orange light (wavelength: 590 to 600 nm), it may be combined with a blue light-emitting layer using perylene or the like as the luminescent material to emit white light having high color purity. Also, because the luminescent material used in the red-orange light-emitting layer in the present invention has high life characteristics, a white light-emitting organic EL element superior in life characteristics can be produced.

Also, the organic EL element of the present invention may be made into a luminous layer which emits light having a desired color by disposing a color filter on the light emitting side of the red-orange light-emitting layer and blue light-emitting layer. Also, the organic EL element of the present invention may be made into a display allowing full-color displaying by providing a color filter of a three colors of R, G and B or four colors of R, G, B and W (W white dolor) as the color filter.

The luminescent material of the present invention shown in the above formula (4) may be synthesized, for example, according to the reaction formula (7) or (8).

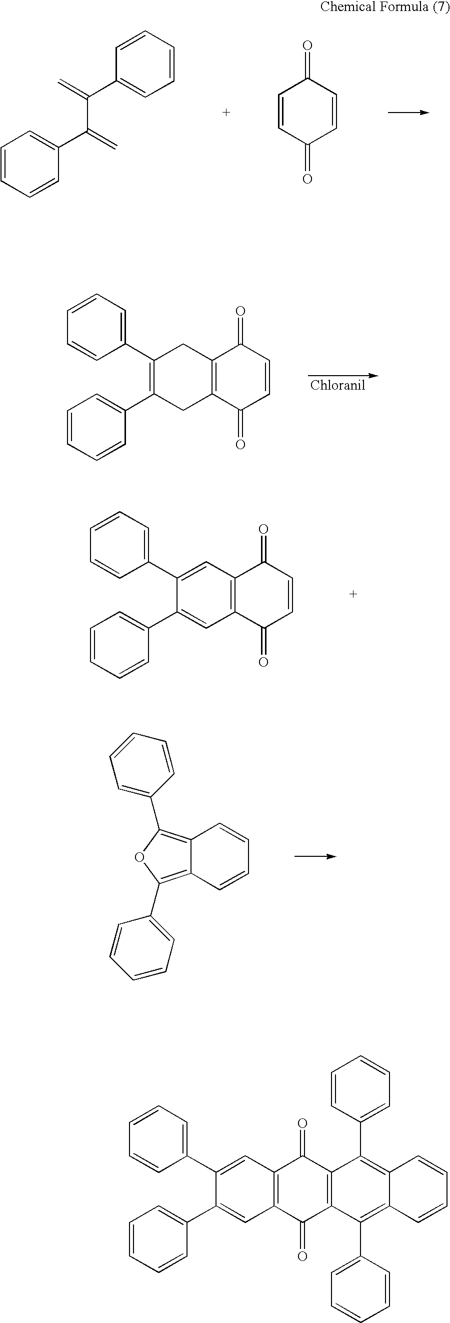

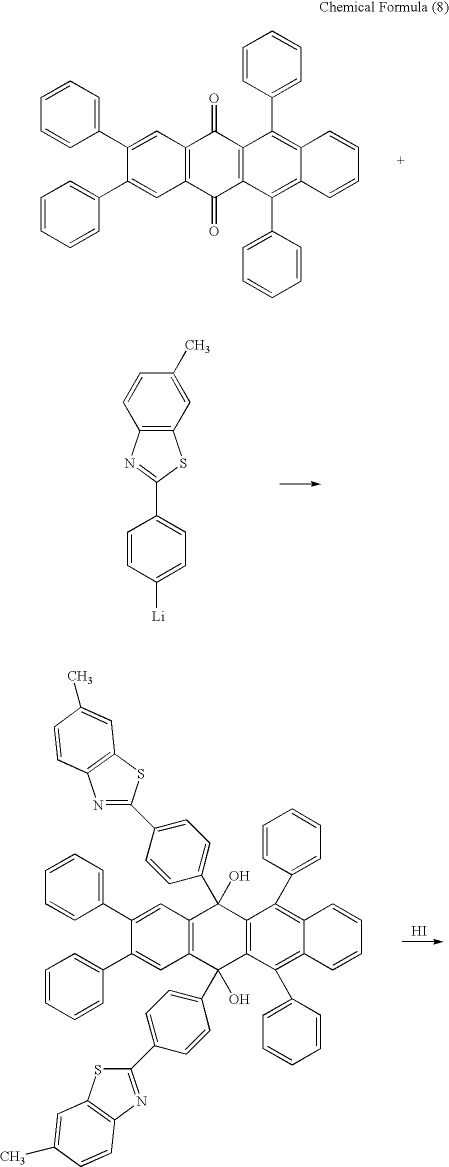

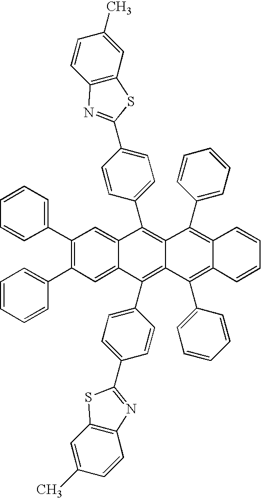

Also, the lithium compound used in the above (8) may be synthesized by the following method (9).

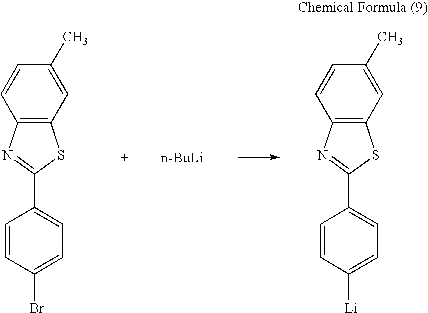

Other luminescent materials according to the present invention may be produced in the same method that is used in the above synthesis.

### BRIEF DESCRIPTION OF THE DRAWINGS

FIG. 1 is a sectional view showing one example of an organic EL element in the present invention.

### DESCRIPTION OF THE PREFERRED EMBODIMENTS

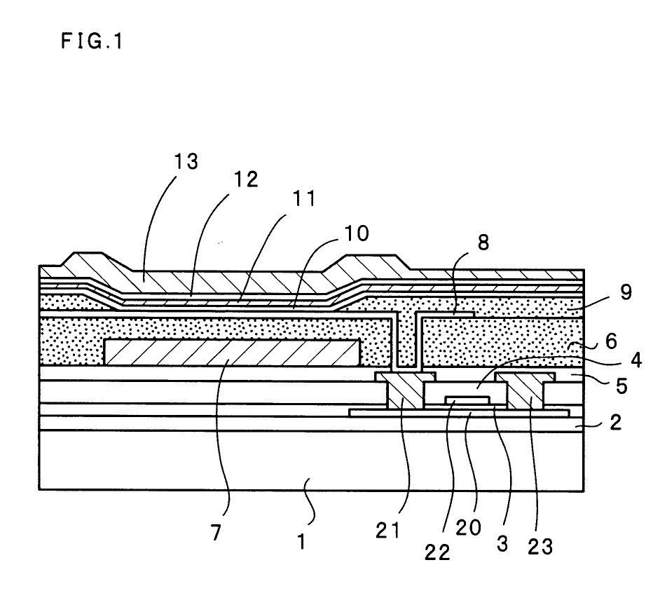

FIG. 1 is a sectional view showing one example of an organic EL element according to the present invention. In this organic EL element, ON-OFF of the emission of each pixel is operated by TFT. Also, this organic EL element is provided with a color filter.

With reference to FIG. 1, a first dielectric layer 2 is disposed on a substrate 1 constituted of a transparent substrate such as glass. The first dielectric layer 2 is formed of, for instance, SiO₂ or SiNₓ. A channel region 20 constituted of a polysilicon layer is formed on the first dielectric layer 2. A drain electrode 21 and a source electrode 23 are formed on the channel region 20 and agate electrode 22 is disposed between the drain electrode 21 and the source electrode 23 through the second dielectric layer 3. A fourth dielectric layer 4 is disposed on the gate electrode 22. The second dielectric layer 3 is formed of, for instance, SiNₓ or SiO₂ and the third dielectric layer 4 is formed of, for instance, SiO₂ or SiNₓ.

A fourth dielectric layer 5 is formed on the third dielectric layer 4. The fourth dielectric layer 5 is formed of, for instance, SiNₓ. A color filter layer 7 is disposed in the part of the pixel region on the fourth dielectric layer 5. As the color filter layer 7, color filters such as a R (red) color filter, a G (green) color filter and a B (blue) color filter are formed. A first flattened film 6 is disposed on the color filter layer 7. A through-hole part is formed in the first flattened film 6 above the drain electrode 21 and a hole injection electrode 8 constituted of ITO (indium-tin oxide) and formed on the first flattened film 6 is introduced into the inside of the through-hole. A hole injection layer 10 is formed on the hole injection electrode 8 in the pixel region. A second flattened film 9 is formed in a part other than the pixel region.

A luminous layer 11 is disposed on the hole injection layer 10. Here, the luminous layer 11 is one having a two-layer structure in which a blue light-emitting layer is laminated on a red-orange light-emitting layer. An electron transfer layer 12 is disposed on the luminous layer 11 and an electron injection electrode (cathode) 13 is disposed on the electron transfer layer 12.

In the organic EL element of this embodiment as mentioned above, the hole injection electrode 8, the hole injection layer 10, the luminous layer 11 having a two-layer structure containing the red-orange light-emitting layer and the blue light-emitting layer, the electron transfer layer 12 and the electron injection electrode 13 are laminated on the pixel region, to constitute the organic EL element.

In the luminous layer 11, the red-orange light-emitting layer and the blue light-emitting layer are laminated and therefore white light is emitted from the luminous layer 11. This white light is emitted outside through the substrate 1. In this case, the color filter layer 7 is disposed on the luminous side and therefore R, G or B color light is emitted corresponding to the color of the color filter layer 7.

In the organic EL element of the present invention, pixels provided with no color filter may be formed to emit white light.

### EXAMPLES 1 TO 3

Using the materials shown in Table 1, a hole injection layer, a hole transfer layer, a red-orange light-emitting layer, a blue light-emitting layer, an electron transfer layer and a cathode (electron injection electrode) were formed. In the table, the numerals in the parenthesis show the thickness (nm) of each layer.

The compound 1 used in the red-orange light-emitting layer is the luminescent material represented by the above formula (4) according to the present invention, the compound 2 is the luminescent material represented by the above formula (5) according to the present invention and the compound 3 is the luminescent material represented by the above formula (6) according to the present invention.

The compound 4 used in the blue light-emitting layer is 2-tertiary-butyl-9,10-di (β-naphthyl) anthracene and a compound having the following structural formula.

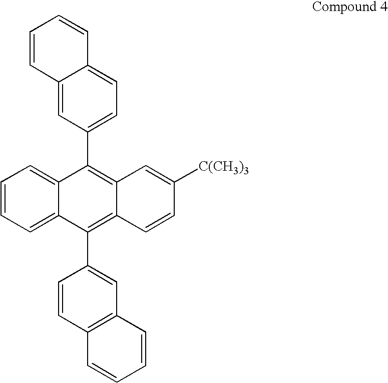

Perylene used in the blue light-emitting layer is a compound having the following structural formula.

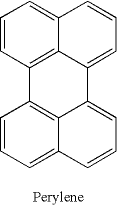

NPB used in the hole transfer layer and in the luminous layer N,N′-di(naphthacene-1-yl)-N,N′-diphenylbenzidine and is a compound having the following structural formula.

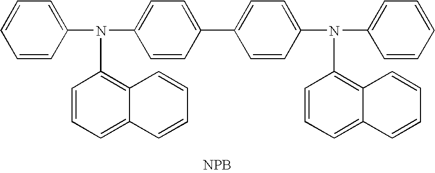

tBuDPN used in the luminous layer is 5,12-bis (4-tertiary-butylphenyl) naphthacene and is a compound having the following structural formula.

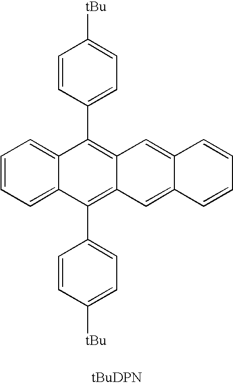

Alq used in the electron transfer layer is tris(8-hydroxyquinolinorate)aluminum and is a compound having the following structural formula.

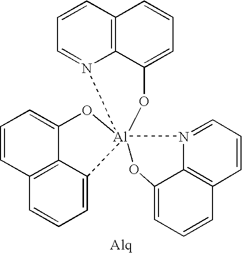

The cathode (electron injection electrode) is formed by laminating LiF and Al.

The red-orange light-emitting layer uses NPB as the host material and the compounds 1 to 3 as the light-emitting dopant. Also, tBuDPN is used as an auxiliary dopant which serves to control carrier transfer in the luminous layer and to transfer energy to the light-emitting dopant. In the blue light-emitting layer, the compound 4 is used as a host material, perylene as the light-emitting dopant and NPB as the auxiliary dopant. “%” in each luminous layer indicates “% by weight”.

In Examples 1 to 3 shown in Table 1, each layer is formed by a vacuum deposition method.

### Comparative Examples 1 and 2

As shown in Table 2, NPB is used as the host material, diphenylpentacene is used as the light-emitting dopant and tBuDPN is used as the auxiliary dopant in the red-orange light-emitting layer of Comparative Example 1. Also, in the red-orange light-emitting layer of Comparative Example 2, NPB is used as the host material, the compound 5 is used as the light-emitting dopant and tBuDPN is used as the auxiliary dopant.

The aforementioned diphenylpentacene has the following structural formula.

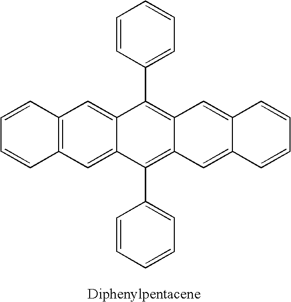

The compound 5 has the following structural formula.

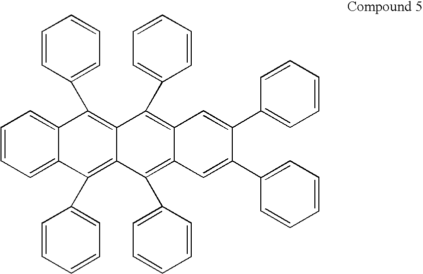

(Evaluation of Luminous Characteristics)

With regard to the organic EL elements obtained in Examples 1 to 3 and Comparative Examples 1 and 2 as shown in Tables 1 and 2, luminous characteristics were evaluated. The results of evaluation are shown in Tables 1 and 2. The life is expressed as a half-life during which the emission intensity is decreased from 1500 cd/M² to 750 cd/m².

TABLE 1

| | Hole | Hole | Red-Orange | Blue Light- | Electron | | | Efficacy | Voltage | | Life (Half |
|---|---|---|---|---|---|---|---|---|---|---|---|
| | Injection | Transfer | Light-Emitting | Emitting | Transfer | | | at 20 | at 20 | Emission | Life) at |
| Ex. | Layer | Layer | Layer | Layer | Layer | Cathode | | mA/cm² | mA/cm² | Color | 5000 cd/m² |
| 1 | CFx | NPB(240) | NPB + 3% | Compound4 + 2.5% | Alq(10) | LiF(1) | Al(250) | 10.1 cd/A | 6.8 V | White | 1700 hr |
| | | | Compound1 + 20% | Perylene + 7% | | | | | | | |
| | | | tBuDPN(30) | NPB(40) | | | | | | | |
| 2 | CFx | NPB(240) | NPB + 3% | Compound4 + 2.5% | Alq(10) | LiF(1) | Al(250) | 10.2 cd/A | 6.7 V | White | 1800 hr |
| | | | Compound2 + 20% | Perylene + 7% | | | | | | | |
| | | | tBuDPN(30) | NPB(40) | | | | | | | |
| 3 | CFx | NPB(240) | NPB + 3% | Compound4 + 2.5% | Alq(10) | LiF(1) | Al(250) | 9.3 cd/A | 6.9 V | White | 1500 hr |
| | | | Compound3 + 20% | Perylene + 7% | | | | | | | |
| | | | tBuDPN(30) | NPB(40) | | | | | | | |

TABLE 2

| | Hole | Hole | Red-Orange | | Electron | | | Efficacy | Voltage | Emis- | Life (Half |
|---|---|---|---|---|---|---|---|---|---|---|---|
| Comp. | Injection | Transfer | Light- | Blue Light- | Transfer | | | at 20 | at 20 | sion | Life) at |
| Ex. | Layer | Layer | Emitting Layer | Emitting Layer | Layer | Cathode | | mA/cm² | mA/cm² | Color | 5000 cd/m² |
| 1 | CFx | NPB | NPB + 3% | Compound4 + 2.5% | Alq(10) | LiF(1) | Al(250) | 4.0 cd/A | 8.2 V | White | 400 hr |
| | | (240) | Diphenylpentacene + | Perylene + 7% | | | | | | | |
| | | | 20% tBuDPN(30) | NPB(40) | | | | | | | |
| 2 | CFx | NPB | NPB + 3% | Compound4 + 2.5% | Alq(10) | LiF(1) | Al(250) | 6.0 cd/A | 8.0 V | White | 900 hr |
| | | (240) | Compound5 + | Perylene + 7% | | | | | | | |
| | | | 20% tBuDPN(30) | NPB(40) | | | | | | | |

It is found from the comparison between the data shown in Tables 1 and 2 that luminescent materials according to the present invention may be used as the luminescent materials of the red-orange light-emitting layer to thereby make a white light-emitting organic EL element which has high luminous efficacy and is superior in life characteristics.

1. An organic electroluminescent element comprising a red-orange light-emitting layer and a blue light-emitting layer which are laminated on each other and disposed between a pair of electrodes, wherein the red-orange light-emitting layer contains a luminescent material represented by the following formula (1): 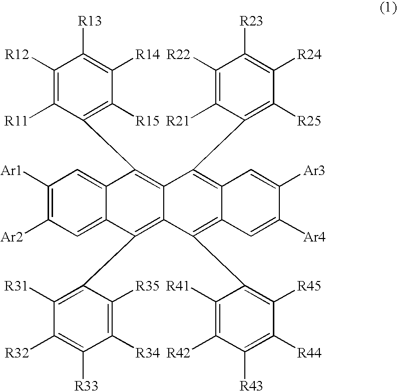
wherein R11 to R15, R21 to R25, R31 to R35 and R41 to R45, which may be identical to or different from each other, respectively represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a heterocyclic group represented by the following formula (2), provided that at least one of these groups is a heterocyclic group and Ar1 to Ar4, which may be identical to or different from each other, respectively represent an aromatic substituent selected from the group (3) represented by the following formula: 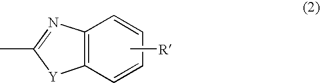
wherein Y represents oxygen (O) or sulfur (S), R′ represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a phenyl group; 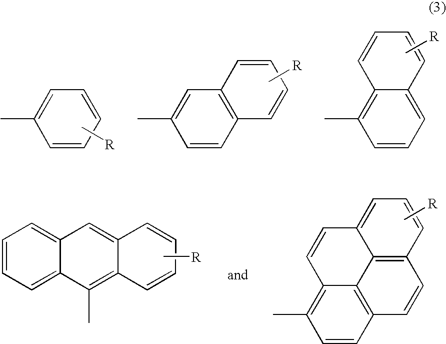
wherein R represent hydrogen, an alkyl group represented by —CₙH₂ₙ₊₁ (n denotes an integer from 1 to 10), an alkoxy group represented by —OCₙH₂ₙ₊₁ (n denotes an integer from 1 to 10), a dialkylamino group represented by —N(CₙH₂ₙ₊₁)₂ (n denotes an integer from 1 to 10), fluorine, chlorine, bromine, iodine, a cyano group or a phenyl group.

2. An organic electroluminescent element according to claim 1, wherein said luminescent material is represented by the following formula (4):

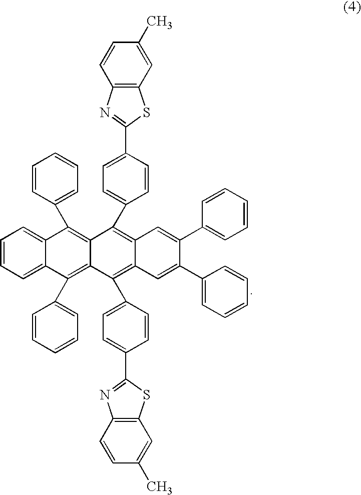

3. An organic electroluminescent element according to claim 1, wherein said luminescent material is represented by the following formula (5):

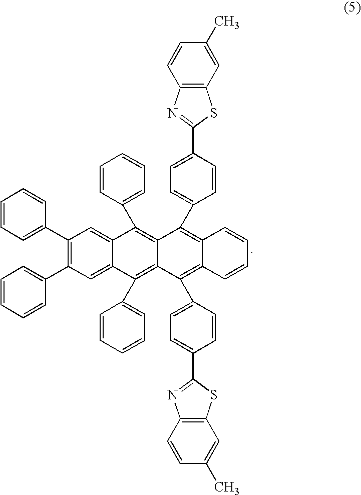

4. An organic electroluminescent element according to claim 1, wherein said luminescent material is represented by the following formula (6):

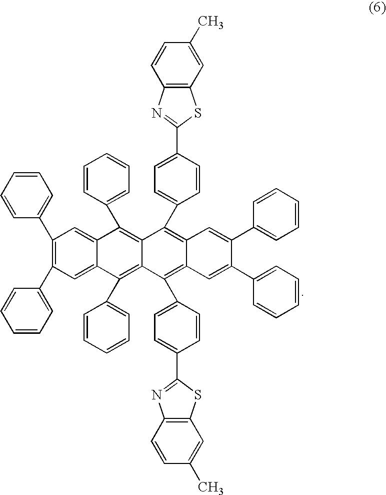

5. An organic electroluminescent element according to claim 1, the element further comprising a color filter disposed on the emission side of said red-orange light-emitting layer and blue light-emitting layer.

6. An organic electroluminescent element according to claim 2, the element further comprising a color filter disposed on the emission side of said red-orange light-emitting layer and blue light-emitting layer.

7. An organic electroluminescent element according to claim 3, the element further comprising a color filter disposed on the emission side of said red-orange light-emitting layer and blue light-emitting layer.

8. An organic electroluminescent element according to claim 4, the element further comprising a color filter disposed on the emission side of said red-orange light-emitting layer and blue light-emitting layer.
